(19) United States
(12) Patent Application Publication
(10) Pub. No.: US 2016/0359819 A1
(43) Pub. Date: Dec. 8, 2016

(54) Encryption and Distribution of Health-related Data

(71) Applicant: vitaTrackr, Inc., West Friendship, MD (US)

(72) Inventors: Howard Patterson Hezmall, Arlington, TX (US); Brian Baum, West Friendship, MD (US); Mark Calem, Oakton, VA (US)

(21) Appl. No.: 14/620,331

(22) Filed: Feb. 12, 2015

Related U.S. Application Data
(63) Continuation of application No. 14/614,394, filed on Feb. 4, 2015.

(51) Int. Cl. H04L 29/06; G06F 21/62; G06F 21/60

(52) U.S. Cl. CPC H04L 63/0435; G06F 21/602; G06F 21/6263; G06Q 2220/10

(57) ABSTRACT

System and methods to reversibly encrypt source identification data from health-related information are described allowing the distribution of health-related information to multiple subscribers while remaining under the control of patient consent directives.

### BACKGROUND OF THE INVENTION

Electronic sharing of health-related information is perceived as a requirement for the advancement of the medical arts. In an effort to advance the medical arts, the United States government has provided incentives in excess of $20 billion dollars to medical practitioners for the use of electronic medical records (EMR). However, hundreds of Health Information Exchanges (HIE) are failing despite these government incentives. Predictions claim as few as 10% of public HIEs will survive after termination of government subsidies. Despite the acknowledged advantages the exchange of EMR has on efficient and effective delivery of medical treatment, over 85% of potential HIE participants refuse to pay the annual fees required by public exchanges.

As an alternative, non-government organizations, hospital groups, and EMR vendors are creating private HIEs that cost less and leverage existing software systems. The number of health information transactions in one private network exceeds 6 billion transactions per year. However, the health-related data exchanged in private HIEs is not guaranteed to be in an electronic representation that is compatible with software systems outside the private HIE. In fact, competition to serve the multi-trillion dollar health care market discourages vendors from making their software systems compatible with competing vendor systems.

Private HIEs fragment access to EMR, meaning patients may not have access to their records when receiving health care from a clinician in another HIE. Similarly, medical researchers do not have the ability to easily access health data across multiple private HIEs to identify effective medical treatment regimes or emerging threats to public health. There is a need to make EMR electronically available outside of private organizations without the cost of fees required by public exchanges. Delivery of medical treatment can be improved by a system that provides dynamic connectivity between any source of health-related information (data source) and any health-related information requester (data destination).

The exchange of EHR outside of health care provider organizations or private HIEs has significant impact on the privacy of patient health-related information. In addition, patients should have the right to control who receives their Personal Health Information (PHI) and how the information can be used. Current approaches have not been successful in providing a widely adopted and geographically extensive sharing of health-related information with meaningful patient privacy controls.

### BRIEF SUMMARY OF THE INVENTION

The invention described herein creates aspects of a marketplace that allows the exchange of many types of health-related information between data sources and data destinations Incoming data is converted by the Marketplace Engine into a canonical format that can be converted into a data representation required by the data destination. This approach maximizes the number of participants able to share data and reduces investment in software that convert existing data representations into standardized formats. Data sources are allowed to require a payment for the data exchange to a data destination. Data destinations are allowed to review available data and offer a payment to data sources for use of their data. People or organizations that are the source of the medical-related data are allowed to specify the conditions under which their data can be exchanged.

### DESCRIPTION OF THE DRAWINGS

FIG. 1 shows a high-level example of the specialized components comprising the Marketplace Engine.

FIG. 2 shows exemplary Marketplace Engine within the health data marketplace and interactions with participants in the health services marketplace.

FIG. 3 shows exemplary steps used by a data source to make data available using the Marketplace Engine.

FIG. 4 shows exemplary steps used to distribute available data to data destinations using the Marketplace Engine.

FIG. 5 shows exemplary steps to encrypt personally identifiable data.

FIG. 6 shows exemplary steps to decrypt personally identifiable data.

FIG. 7 shows exemplary steps used to identify features in source data.

FIG. 8 shows exemplary steps to decrypt feature identification data.

FIG. 9 shows exemplary high-reliance platform.

### EXEMPLARY DESCRIPTION OF THE INVENTION

The invention comprises aspects of a Marketplace Engine that supports a health data marketplace by managing, auditing, reconciling, and executing the exchange of health-related information between data sources and data destinations. The Marketplace Engine acts as part of a data distribution system that supports the exchange of data in the health data marketplace. A data source can be the person the health-related data pertains to (subject), an organization entrusted with the data, or any entity that has authority to release health-related data. A data destination can be any entity authorized to accept health-related data, for example, research organizations, health care provider organizations, payor organizations, health maintenance organizations, etc. The release of health-related information between data sources and data destination is controlled by the consumer though a consent directive. A consumer can be, for example, the subject, the guardian of the subject, or any person or entity with legal authority to give consent.

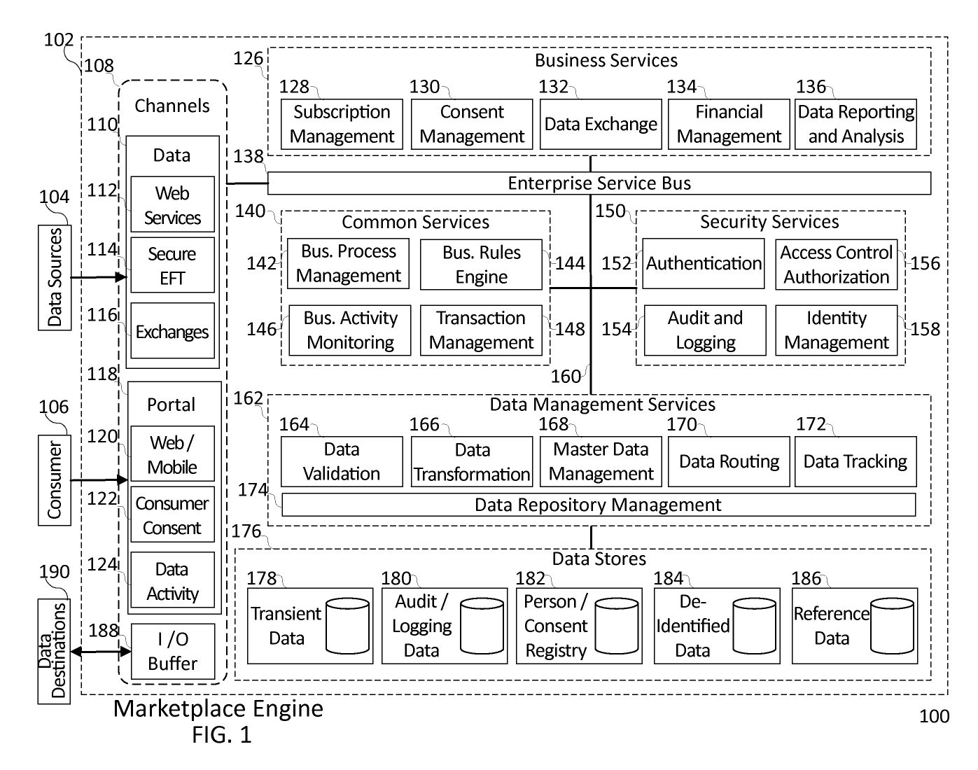

The exemplary details of the Marketplace Engine are shown in FIG. 1. The Marketplace Engine 102 can accept data from data sources 104 and consumers 106 through channels 108. A channel is a unidirectional or bidirectional data path allowing information to flow from data sources and consumers into the Marketplace Engine. Channels include cable (twisted-pair wire, cable, and fiber-optic cable), broadcast (microwave, satellite, radio, and infrared), Wi-Fi (local area wireless technology), etc. Data sources interact with the Marketplace Engine through a data source interface 110 that can be, for example, web services 112, secure electronic file transfer (EFT) 114, or exchanges 116, including health information exchanges (HIE). Data channel 110 allows the exchange of data without requiring a portal or browser application. Examples of data channel 110 include application programming interfaces, remote procedure calls, HL7 messages, HL7 documents, inter-process communication protocols, web services, secure EFT, CORBA, e-mail, Fast Healthcare Interoperability Resources (FHIR) data, mobile data, and other data transfer schemes. Underlying protocols may be organized into high-level profiles, such as the Nationwide Health Information Network (NHIN or NwHIN), NHIN Direct, and epSOS (European Patients Smart Open Services) project, as examples. Web services 112 provide secure web access into the Marketplace Engine, supporting synchronous or asynchronous data transfers, encoded, for example, in eXtensible Markup Language (XML), JavaScript Object Notation (JSON), or some other standard notation. A web service generally has an interface described in a machine-processable format (e.g., WSDL). Systems may interact with a web service in a manner prescribed by its description using SOAP (Simple Object Access Protocol) messages. Web services can be REpresentational State Transfer (REST) compliant or non-REST compliant. Secure EFT 114 provides a mechanism for transfer of information without the need of a web service interface. Secure EFT provides a secure file transfer input for larger data transfers, e.g., “batch” processing. Examples include secure File Transfer Protocol (SFTP) over Transport Layer Security (TLS), Secure Sockets Layer (SSL), Hypertext Transfer Protocol Secure (HTTPS), or other secure file exchange protocols. Exchanges 116 represent, for example, interfaces to Health Information Exchanges (HIES). Exchange capabilities are frequently defined in profiles and standards for the exchange of information, specifically medical information. Examples include NwHIN, NHIN Direct, and esPOS. NwHIN is the Nationwide Health Information Network formerly abbreviated as the NHIN or NwHIN, but now more often referred to as the eHealth Exchange. NHIN Direct (also known as Direct) offers sharing of medical records between trusted parties. epSOS (European Patients Smart Open Services) and OpenNCP (National Contact Point) are additional examples of systems exchanging medical records between parties. Other types of exchanges using different data representations are possible, e.g., between research organizations, government agencies, and academic institutions.

Consumers 106 interact with the Marketplace Engine through, for example, portal 118. A portal may be, for example, a web portal, enterprise portal, internet portal, or a specialized variant. A portal typically uses a web page provided for the exchange of information and can include personal computers, tablets, mobile phones, personal device assistants, as examples. Consumers may use a web portal or a mobile application running on a laptop or a mobile device 120. A mobile application provides support for interaction between the Marketplace Engine and handheld computing devices, which are less than 2 pounds and have a display screen with touch input and/or a miniature keyboard. Consumers can also interact with the Marketplace Engine through a consumer consent portal 122. A consumer consent portal is a component that interacts with a person, guardian, designee, or a computerized agent to establish agreement or permission to do or allow something. Consent can be direct, indirect, implied, or express, for example. A consent directive can be specifically designed to allow creation, modification and cancellation of consent directives. Consumers can also interact with the Marketplace Engine through a portal data activity interface 124. A data activity interface generates information on the activity related to consumer data and may be combined with the consumer consent 122 portal. Data activity interface 124 can be subscription based, email based, or query based, for example.

Interactions from data sources 104 and consumers 106 through channels 108 are transferred using enterprise service bus (ESB) 138. The ESB provides secure and reliable communications between components that comprise the Marketplace Engine using interconnections represented by line 160. The ESB can be used to extend the functionality of the Marketplace Engine over multiple computing resources and/or redundant computer resources, so that one component does not have to be executing on the same computer as another Marketplace Engine component. The ESB may be implemented as part of a service-oriented architecture (SOA). The ESB monitors and controls the routing of messages between Marketplace Engine components.

ESB 138 provides communication between channels 108, business services 126, common services 140, security services 150, data management services 162, data stores 176, and data destinations 190.

In one implementation, business services subsystem 126 provides subscription management 128, consent management 130, and financial management 134 for the Marketplace Engine. In addition, business services 126 can provide data reporting and data analysis 136 and mediate data exchange 132 with and between other components of the Marketplace Engine.

Subscription management 128 provides capabilities that manage the overall transfer of data through the marketplace—whether they originate from a data source, data destination, or Marketplace Engine component. This service is responsible for orchestrating transactions, thus making sure that a data request is received from an authoritative source and using a set of rules, validating, transforming, and routing the data to its destination.

Consent management 130 provides capabilities that support the consent process and ensures that all consent rules and established, managed, and followed. Consent can be, for example, direct (consumers manages the consent for data through a channel), or indirect (where a customers authorize another person, group, or process to manage their consent).

Financial management 134 provides capabilities that track data being sent through the Marketplace Engine and calculates payments to the data sources and charges for those destinations consuming the data. This service utilizes the data stored in the audit and logging database to generate and record the financial transactions between data sources and data destinations.

Data exchange 132 provides capabilities to collect metrics on the exchange of data within the Marketplace Engine, for example, data throughput, data error rates, quality of service (QoS) and resource allocation.

Data reporting and analysis 136 provides services to report on the data exchanged within the Marketplace Engine and monitor how different areas of the Marketplace Engine are performing. Analysis capabilities use various approaches to extract insights on the efficiency of the Marketplace Engine and any deficiencies that should be addressed.

Common services subsystem 140 provides applications, software capabilities, and/or computerized procedures that support other components of the Marketplace Engine that may not be supported directly by the native operating system. These services, including business process management 142, business rules engine 144, business activity monitoring 146, and transaction management 148, can be implemented as a middleware layer and in distributed implementations can be accessed from several servers.

Business process management (BPM) 142 provides the foundation for orchestrating a set of business processes communicated through ESB 138. The BPM common services provides the capabilities for modeling, managing, and executing a set of business processes that together support a Marketplace Engine business service.

Business rules engine 144 provides the capability to author, manage, and execute the business rules needed to support Marketplace Engine business services. The use of a business rules engine provides flexibility and eliminates the need to hardcode logic into the software. Business rules may be encoded in representations such as Drools, Guvnor, or some other rule system, preferably supporting Java Specification Request 94 (JSR-94), or similar functionality written, for example, in a logic programming language (e.g., Prolog), or in another compiled programming language (such as Java, C, C#, or C++) or in an interpreted programming language (such as Perl, or Python).

Business activity monitoring 146 provides capabilities necessary for monitoring the execution of the business processes within the Marketplace Engine. It provides a real-time summary of business activities so that the Marketplace Engine operations support team can track the movement of data through the marketplace to ensure its proper execution.

Transaction management 148 provides computer implemented services to manage the individual transactions flowing through the marketplace to ensure that the transaction is successfully completed. It provides the capabilities to rollback and re-process a transaction in the event of failure.

Security services subsystem 150 provides applications, software capabilities, services, and/or computerized procedures that support authentication 152, audit and logging 154, access control authorization 156, and identity management 158. These services represent the reusable, repeatable, and cross-cutting security capabilities that will be leveraged across the Marketplace Engine.

Authentication 152 provides the Marketplace Engine authentication services for entities, for example, data sources, data destinations, and consumers. These services provide the mechanisms that permit only trusted data sources and data destinations access to the marketplace.

Audit and logging 154 provides capabilities to capture and transmit data concerning specific operations, procedures, events, etc. and any errors or usual activities. Audit and logging 154 may be implemented in a distributed fashion with logging sent to an audit service for processing, which may be executed on another computer or hardware device. Audit and logging data is used, for example, to provide information back to the consumer on their data activity. Audit and logging data also uses Marketplace Engine financial management 134 component.

Access control authorization 156 provides services to control which data sources and data destinations are authorized to perform which functions. Access control authorization 156 also provides the access control for consumers into portal 118.

Identity management 158 provides services to manage the identities of all entities in the marketplace and their identifiers across data sources 104, consumer 106, and data destinations 190. Identity management 158 may leverage standard profiles, such as Integrating the Heath Enterprise (IHE) Patient Identifier Cross-referencing (PIX) Integration Profile, Cross-Community Access (XCA), and/or Cross-Community Patient Discovery (XCPD) to provide this capability.

Data management services subsystem 162 provides applications, services, software capabilities, and/or computerized procedures that support data validation 164, data transformation 166, master data management 168, data routing 170, and data tracking 172. Data management services 162 also provides data repository management 174.

Data validation 164 provides capabilities ensuring programs within the Marketplace Engine operate on clean, correct, and useful data (i.e., acceptable data quality). These capabilities may include analyzing data type, data range, data constraints, cross-referenced data, and structured validation, as examples.

Data transformation 166 converts data values from, for example, the data format of a data source 104 system into the data format of a destination data 190 system based on a set of business rules, criteria, and reference data.

Master data management 168 provides the set of services for collecting, aggregating, matching, and consolidating data to ensure there is a consistent and uniform set of identifiers that are used across the architecture. The services may support the IHE PIX and related profiles for establishing cross-referencing of patient identifiers from multiple Patient Identifier Domains.

Data routing 170 provides services to route data from source to destination within the Marketplace Engine, which could, in a distributed implementation, be across multiple computer resources. Data routing 170 relies, in part, on the data stored in the Marketplace Engine reference database 186 to manage the registered data sources 104 and data destinations 190 to interpret which protocols and integration methods are required by each endpoint.

Data tracking 172 provides services to monitor the transfer and transformation of data across the Marketplace Engine, ensuring that data is correctly conveyed and received by the intended destination.

Data repository management 174 provides services to access data within Marketplace Engine data stores 176, providing an access method into the databases to create uniformity of data access and understanding of data meaning Data repository management 174 also interacts with the high-reliance platform to provide the capability to de-identify consumer-level data for long-term storage.

Data store subsystem 176 comprises repositories holding data objects, including context data. Data store 176 provides storage and retrieval of data associated with transient data 178, audit/logging data 180, person/consent registry 182, de-identified data 184, and reference data 186.

Guaranteed delivery of data held during the processing of transactions is supported by transient data 178, which provides services and computer implemented capabilities used during the operation of the Marketplace Engine.

Audit/Logging data 180 provides services and computer capabilities concerning the processing of requests through the Marketplace Engine that can be used to reflect activity to the user and or participants in the marketplace. Audit/Logging data 180 includes the storage of meta-data for transaction logging to support a transaction history.

Person/Consent registry 182 provides management and storage of data that is used to identify entities and can allow correlation of entities across multiple data sources 104.

De-identified data 184 provides management and storage of data that is stripped of Personally Identifiable Information (PII) that could be associated with PHI. De-identified data 184 provides distribution message identifiers that may also be used in coordination with the high-reliance platform to re-identify the source of PHI for ongoing consent requirements.

Reference data 186 provides management and storage of data for use throughout the Marketplace Engine.

Data destinations 190 provides interfaces through I/O buffer 188 for communications with the Marketplace Engine. Examples of data destinations include health management companies, health plans/payors, health providers, health related businesses (weight management, fitness, etc.,), research institutions, pharmacological companies, Accountable Care Organizations (ACO), life insurance companies, and consumers.

The components, modules, processes, and logical subunits described herein (components) can be implemented as computer software, electronic hardware, or both. The functions of a component may performed on a computer, an application specific integrated circuit (ASIC), a digital signal processor (DSP), special-purpose devices, or other programmable logic device.

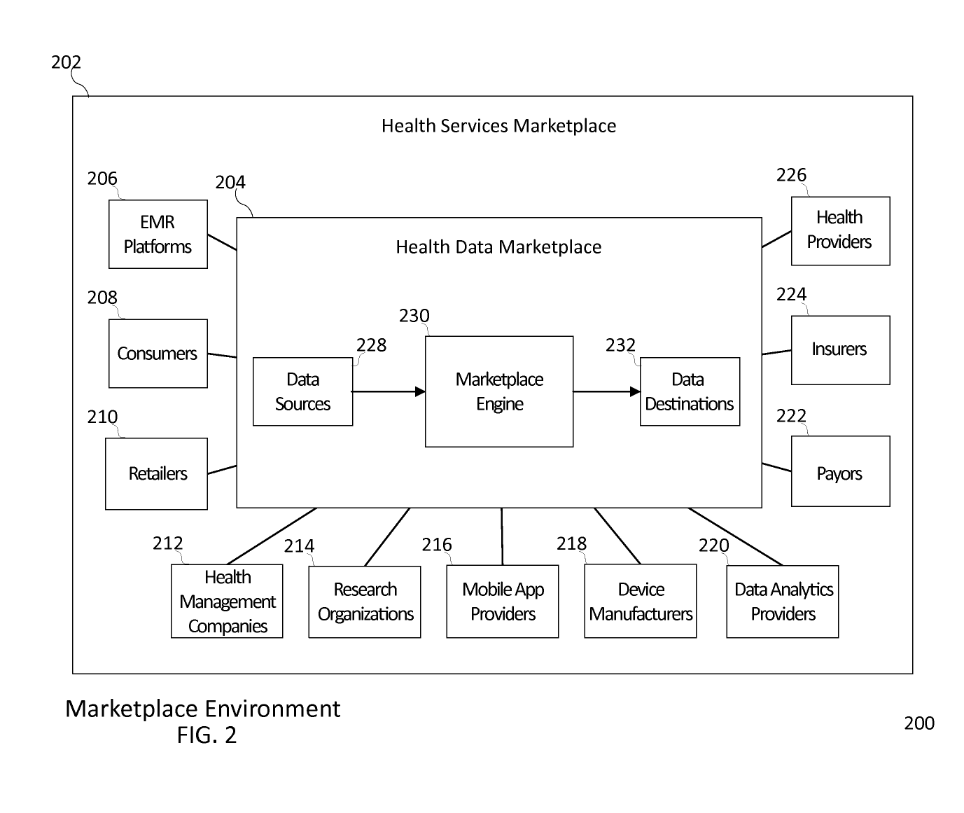

High-level details of how the Marketplace Engine supports the health data marketplace and interactions with participants in the health services marketplace is shown in FIG. 2. The Marketplace Engine 230 uses the core components described in FIG. 1 to facilitate the flow of information between data sources 228 and data destinations 232. Facilitation is defined as accepting the electronic representation of health related information (data format) from a data source (i.e., source data format) and delivering at least part of that information in a data format that can be used by a data destination (i.e., destination data format). The Health Data Marketplace 204 encourages data sources to distribute their data within the marketplace given the ease of making their data widely available and possibly receiving compensation for their data. Likewise, destinations are naturally incented to come to the marketplace because it simplifies access to a multitude of data sources.

The availability of Health Data Marketplace 204 supports the development of Health Services Marketplace 202 by providing new data creation opportunities and provide greater value through data enhancement. Data enhancement is defined as the process of making raw data more quantitatively or qualitatively valuable. The financial incentive in offering either raw or enhanced data as a data source and the ability to access valuable data as a data destination provides the financial support to operate the Health Data Marketplace 204 without the cost of fees required by public exchanges.

Participants in Health Services Marketplace 202 include EMR platforms 206. EMR platforms support an electronic representation of medical history and treatment history of patients (e.g., registration data, clinical reports, lab results, etc.) and can either provide (e.g., to other health providers 226, insurers 224, payors 222, health management companies 212, etc.) or consume data from the Health Data Marketplace. Consumers 208, which may be patients, can provide information (to researchers 214, health management companies 212 health providers 226, etc.) through, for example, mobile applications, wearable/implantable devices, personal health record (PHR) applications or Marketplace Engine portal. Consumers 208, also interact with the Marketplace Engine 230 to set constraints for sharing their information by Health Service Marketplace participants in the Health Data Marketplace. Retailers 210 (e.g., grocery, pharmacy, shopping malls, etc.) can provide data from ancillary services (e.g., cholesterol, blood pressure, blood glucose test, etc.). Health management companies 212 can consume data for risk assessment analysis, intervention and coaching programs, and outcomes tracking Research organizations 214 can consume data (e.g., for drug discovery, public health, basic research, etc.) or provide data (e.g. to other research organizations). Mobile application (app) providers 216 can provide data (e.g. to research organizations 214, health management companies 212, EMR platforms 206, consumers 208, etc.) or consume data, e.g. from health providers 226, device manufacturers 218, health management companies 212, data analytics providers 220, etc.). Device manufacturers 218 offering wearable, implantable, discretionary, and/or prescribed devices, provide data to consumers 208, health management companies 212, research organizations 214, mobile app providers 216, data analytics providers 220, etc. Data analytics providers 220, consume data (e.g., from consumers 208, EMR platforms 206, retailers 210, health management companies 212, mobile app providers 216, device manufacturers 218, health providers 226, etc.) and provide data (e.g., to health management companies 212, research organizations 214, payors 222, insurers 224, health providers 226. Payors 224 (health medical organizations (HMO), benefit plans, government, etc.) and insurers 224 both consume data (e.g., from consumers 208, EMR platforms 206, health management companies 212, health providers 226, etc.) and provide data (e.g., to health management companies 212, research organizations 214, health providers 226, etc.). Health providers 226 consume data (e.g., from other health providers 226, consumers 208, EMR platforms 206, retailers 210, health management companies 212, mobile app providers 216, device manufacturers 218, other health providers 226, etc.) and provide data (e.g., to health management companies 212, research organizations 214, payors 222, insurers 224, health providers 226). A non-limiting list of data sources and data destinations is found in Table 1.

TABLE 1
Example Data Sources and Data Destinations

| Data Sources | Data Destinations |
|---|---|
| Self-service health | Health management |
| assessment kiosks | companies |
| Personal health | Health plans/payors |
| monitoring devices | |
| Mobile health | Health providers |
| applications | |
| Wireless, in-home, and | Health related businesses |
| implantable health | (e.g. weight |
| monitoring devices | management, fitness, |
| | etc.) |
| Lab data | Research institutions |
| Clinical health record | Pharmaceutical |
| data | companies |
| EMR platforms | Accountable Care |
| | Organizations (ACO) |
| Consumers | Life Insurance |
| | companies |
| | Consumers |

The incentive to join the health services marketplace 202 increases as more data sources 228 and data destinations 232 are available through the health data marketplace 204. The Marketplace Engine 230 provides the capabilities to facilitate the exchange of data in different representations across the marketplace. Data can be represented is many formats depending on its use, for example, research organizations 214 using Clinical Data Interchange Standards Consortium (CDISC) standards, EMR platforms 206 using Health Level Seven (HL7) Clinical Document Architecture (CDA) or messaging, health providers 226 using Logical Observation Identifiers Names and Codes (LOINC), Systematized Nomenclature of Medicine Clinical Terms (SNOMED), RxNorm, device manufacturers 218 using Digital Imaging and Communications in Medicine (DICOM), payor 222 using International Classification of Diseases ICD-9 or ICD-10. Additional data representations used in Electronic Data Interchange (EDI) include JPEG (originally an initialization of Joint Photographic Experts Group), Portable Document Format (PDF), Graphics Interchange Format (GIF), Portable Network Graphics (PNG), and XML.

The Marketplace Engine supports different exchange modalities of information between data source and data destination. Typically, data is exchanged over a computer network. Network is defined as data connections that allow devices to send and receive data. The data can be exchanged asynchronously or synchronously, depending on the requirements or configuration of the data source and data destination. Delivery of the data can be over various communications protocols, for example, Transmission Control Protocol (TCP) (e.g., http, https, s-http, etc.), User Datagram Protocol (UDP) (e.g., multicasting and broadcasting), multiplexing protocols (e.g., Synchronous optical networking (SONET)), and non-IP-based networks, (e.g., X.25, Frame Relay and ATM).

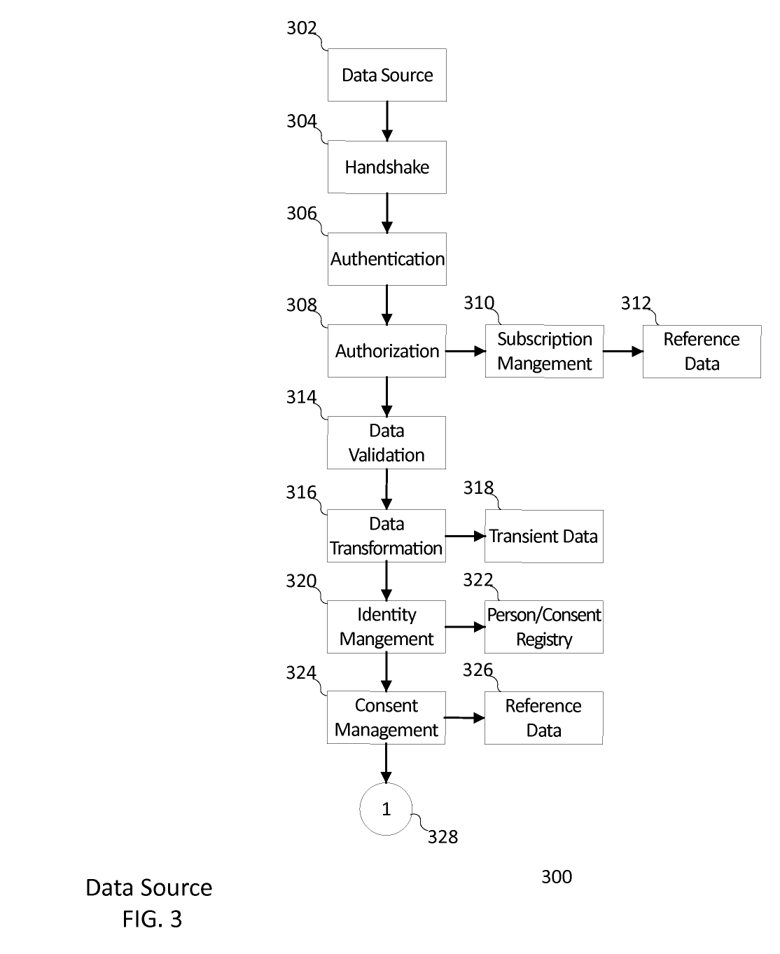

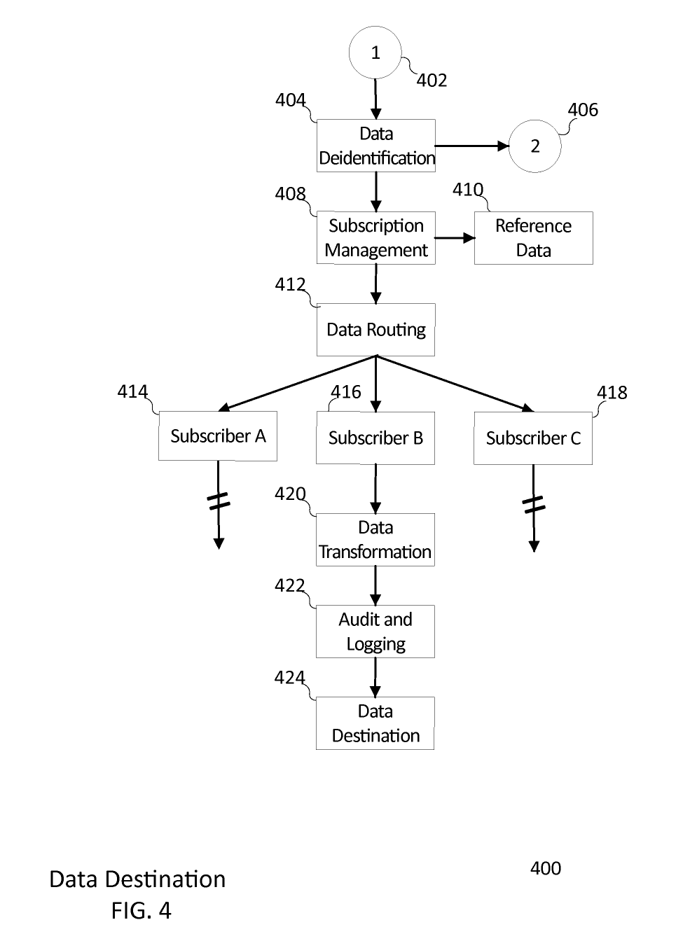

The high-level details of how components of the Marketplace Engine exchange health data between data sources and data destinations is shown in FIG. 3 and FIG. 4. In FIG. 3 data is received, for example, from data source 302 through a data connection, e.g., a network, by one of the data components in the channel subsystem, shown as “handshake” 304. Handshake represents sequences of data exchanged to set up and transfer information on one or more transport layers found, for example, in the Open Systems Interconnection model (OSI) conceptual model. Authentication component 306 identifies the data source using, for example, a digital certificate, shared secret, or identifying token. If the authentication information is verified by authentication component 306, authorization component 308 determines what data and actions the data source will be allowed to perform based on reference data 312 and subscription management 310. Authorization may be based on permissions in a database, flat file, access list, policy object, hardware token, or determined using Role Based Access Control (RBAC), Attribute Based Access Control (ABAC), Rule-Based Access Control (RuBAC) or other Mandatory Access Control (MAC) or Discretionary Access Control (DAC) mechanisms.

Authorized data received from data source 302 is processed by data validation component 314 to ensure the data is consistent with the expected data format. The data format can be determined by data validation component 314 by examining the data itself or from information stored in the Marketplace Engine, e.g. reference data 312. Validated data is transformed by data transformation component 316 into a standard data representation called the canonical representation and stored in transient data component 318. Transformation into and out of canonical representation can be done locally or by specially configured hardware-based devices that convert data using techniques such as shared physical memory, “Structured Query Language” (SQL) databases (e.g., relational database management system (RDBMS) or relational data stream management system (RDSMS), non-tabular “Not Only SQL” (NoSQL) database, data warehouses, or a distributed key/value store (e.g., accumulo). Identity management 320 uses data stores, including person/consent registry 322, to identify all subjects from which consent must be obtained before the release of the transformed data. Consent management component 324 then determines if distribution of all or part of the transformed data is permitted. Data ready for distribution is passed onto additional steps signified by the symbol at 328. Distribution may require, for example, contacting the identified subject, evaluating consent based on the subject's consent policy, or overriding consent requirements based on, for example, legal obligations. Steps in the processing of data from data sources may be logged in the audit and logging component 154. Each opportunity to consent to use of data from the data source is also sent to audit and logging component 154, allowing a summary of consent events for presentation to the consenter. Restrictions on the release of data and any obligations on the recipient of the data can be stored in reference data 326.

Health Service Marketplace participants in the Health Data Marketplace may provide different types data elements based on the category the data source provides the data subject. A non-limiting list of example data source categories and example data elements is found in Table 2.

TABLE 2
Example Categories of Data Sources

| Category | Data Element |
|---|---|
| Device | Kiosk - biometrics |
| | Activity monitors |
| | Heart rate monitors |
| | Blood pressure monitors |
| | Glucose monitors |
| | Spirometers |
| | Sleep monitors |
| | Scales |
| Lab data | Specific data values, e.g., |
| | cholesterol |
| | measurements |
| Alternate clinics | Retail clinics |
| | Worksite screenings |
| | Urgent care clinics |
| Pharmacy | Prescription data |
| | Ancillary services, e.g., |
| | vaccinations, screenings |

FIG. 4 illustrates the distribution of data from the consent management component 328 after the consent event, as indicated at 402. Data may be appropriately exchanged with personally identifiably information (PII), such as the transfer of a patient to a new health care provider, the transfer of a clinical summary document to an emergency clinic, the transfer of treatment records substantiating payment, etc. However, sometimes it is not appropriate to include PII in the exchange of data. Data de-identification 404 determines if removal of PII is appropriate by analyzing, for example, consent of the subject, agreement of the parties, or application law. During de-identification, any PII (i.e., PII data) is routed to additional components as signified by the symbol at 406 where data can be encrypted in case re-identification is required. PII data can be associated with data sent to subscribers using distribution message identifiers. Distribution message identifiers can be associated to PII storage requests using, for example, a PII retrieval request.

PII can be identified and separated at 404 using domain analysis models (DAM) that describe structured data fields that typically contain PII. Alternatively, or in addition to, data can be scanned for specific terms or data formats (e.g., social security numbers, zip codes, etc.). Data in the original data stream that is identified as PII data can be routed separately (herein referred to as the PII data stream). The remainder of the data, i.e., data in the original data stream that is identified as not being PII data (herein referred to as the non-PII health-related information data stream), can be routed separately from the PII data stream. Examples of specific terms or data formats that can indicate PII data taken from NIST Special Publication 800-122, “Guide to Protecting the Confidentiality of Personally Identifiable Information (PII)” are summarized in Table 3.

TABLE 3
Example PII Terms

| Category | Examples |
|---|---|
| Name | Full name |
| | Maiden name |
| | Mother's maiden name |
| | Alias |
| Personal identification | Social security number |
| number | Passport number |
| | Driver's license number |
| | Taxpayer identification |
| | number |
| | patient identification |
| | number |
| | Credit card number |
| Address information | Street address |
| | Email address |
| Asset identification | Internet Protocol (IP) |
| | Address |
| | Media Access Control |
| | (MAC) address |
| | Persistent static identifier |
| Telephone numbers | Mobile number |
| | Business number |
| | Personal number |
| Personal characteristics | Facial photographic image |
| | Fingerprints |
| | Retina scan |
| | Voice signature |
| | Facial geometry |
| Information identifying | Vehicle registration |
| personally owned | number |
| property | Title number |
| Information about an | Date of birth |
| individual that is linked | Place of birth |
| or linkable to one of the | Geographical indicators |
| above | Employment information |
| | Education information |
| | Financial information |

As described in the European Union Data Protection Standard, PII can be information relating to a person who can be identified, directly or indirectly, in particular by reference to one or more factors specific to his physical, physiological, mental, economic, cultural, or social identity.

Properly processed data passes to subscription management 408 that determines the data destinations using reference data 410. Determination of the data destination may be implemented as a subscription service, for example, allowing parties to subscribe to specific types or sources of source data. Determining appropriate subscribers may be done using, for example, a data base, flat file, hashed data object, or other data structures collected during on-boarding of the subscriber. Data routing 412 routes all or part of the data as appropriate to zero or more subscribers, shown in FIG. 4 as subscribers A (414), B (416), and C (418) to illustrate the data flow. For purposes of illustration, FIG. 4 shows data routed to subscribers B (416) and the transformation by data component 422 from the canonical format into the format expected by the subscriber. Appropriately processed data can be sent to additional subscribers as indicated by the broken arrow symbols in the figure. Information, including distribution message identifier, data source, data subject, and data destination, is sent to audit and logging system 420 before release to data destination 424. Audit information can be used to inform the subject where data associated with them has been sent, including, e.g., how and when authorization was granted. Audit information is also used to reconcile financial transactions between marketplace participants.

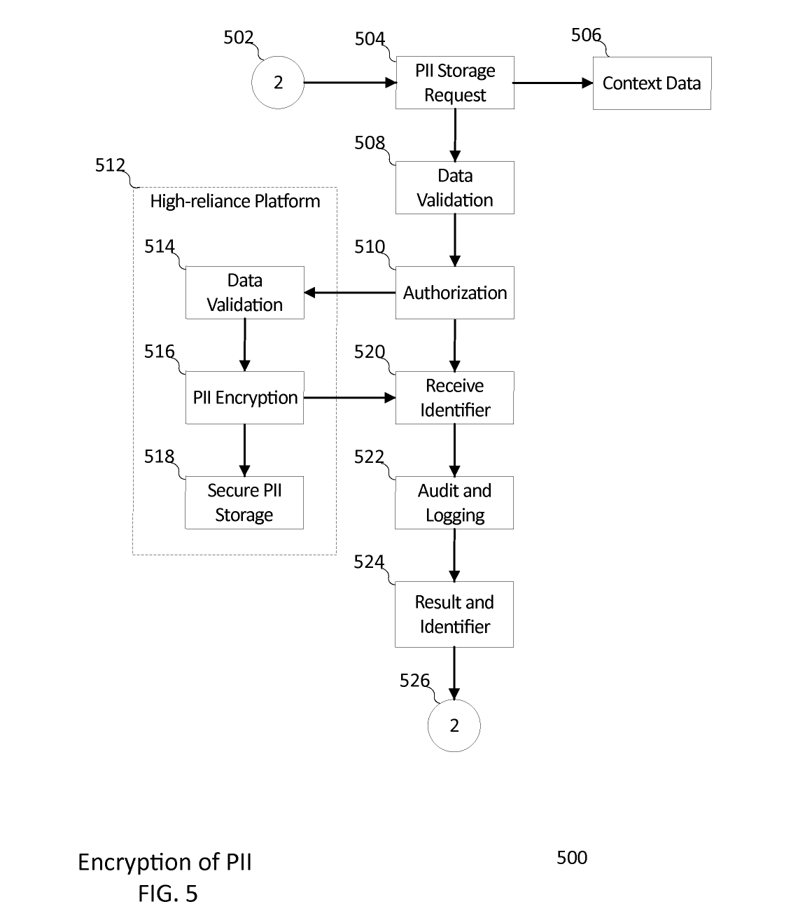

An example of the encryption of PII data is described in FIG. 5. PII data sent from 406 with a PII storage request, symbolized at 502. PII data and the PII storage request are identified at 504, and preferably augmented with context data 506. Identification of data that is PII may depend on canonical field, the format of the data, additional data in context data 506, etc. The PII storage request and the PII data are validated at 508 and passed to the high-reliance platform 512 if authorized at 510. Authorization can be based on entity information in the PII storage request compared to subscription information, permissions in a database, flat file, access list, policy object, hardware token, or determined using Role Based Access Control (RBAC), Attribute Based Access Control (ABAC), Rule-Based Access Control (RuBAC) or other Mandatory Access Control (MAC) or Discretionary Access Control (DAC) mechanisms. Data validation can include, for example, analyzing data type, data range, data constraints, cross-referenced data, and data structures.

PII data removed from raw data may need to be preserved to substantiate the exchange during audit, identify the subject in case of medical emergency, contact the subject and/or consenter in case additional consent is requested, etc. Possible mechanisms to securely store information in an encrypted form include symmetric encryption (using stream ciphers, block ciphers, etc.), asymmetric encryption (using integer factorization, discrete logarithm, elliptic curve relationships, etc.), message authentication codes for message assurance, etc. Examples of ciphers used encrypt data include Advanced Encryption Standard (AES), RSA, and SHA-256. If asymmetric encryption is implemented to store PII data, public and private keys can be used to encrypt and decrypt protected information. The high-reliance platform comprises special purpose hardware that stores cryptographic keys used to encrypt or decrypt PII data stored within the high-reliance platform. Preferably, high-reliance platform 512 complies with National Institute of Standards and Technology (NIST) Federal Information Processing Standards Publication (FIPS PUB) 140-2 or equivalent. More specifically, the high-reliance platform complies with FIPS PUB 140-2 security level 2 and above. FIPS PUB 140-2 security level 2 and above require specific hardware requirements summarized in Table 4.

TABLE 4
FIPS 140-2 Special Hardware Requirements

| Security | |
|---|---|
| Level | Requirements |
| 1 | At least one approved algorithm or |
| | approved security function, no specific |
| | physical security mechanisms are required. |
| 2 | Features that show evidence of tampering, |
| | including tamper-evident coatings or seals |
| | that must be broken to attain physical |
| | access to the plaintext cryptographic keys |
| | and critical security parameters. |
| 3 | Physical security intended to have a high |
| | probability of detecting and responding to |
| | attempts at physical access, use or |
| | modification of the cryptographic module. |
| 4 | Physical security intended to detect |
| | penetration of the cryptographic module |
| | enclosure resulting in the immediate |
| | zeroization of all plaintext critical security |
| | parameters. |

High-reliance platform 512 can run an isolated environment separated from the Marketplace Engine and can be accessible by the Marketplace Engine through a secure data connection, for example using Transport Layer Security (TLS) or equivalent.

High-reliance platform 512 generates cryptographic keys within a cryptographic module, which may be an asymmetrical key pair, a symmetrical key, or equivalent cryptographic parameters. Multiple high-reliance platforms can be used to support fail-over of a high-reliance platform. Cryptographic keys remain within the cryptographic module in the high-reliance platform. Encrypted data is stored by the high-reliance platform in secure PII storage 518. Successful encryption and storage is reported by 516 along with a PII storage identifier to component 520 and recorded by audit and logging 522. The PII storage identifier, PII storage request identifier, and result is made available to the requester at 524, symbolized at 526. The Marketplace Engine can store the association of the PII storage request identifier to the PII storage identifier using and, optionally, related distribution message identifiers, using a data base, flat file, hashed data object, or other data structures. The encryption process described herein allows secure storage of PII data in a way that can be unencrypted by the Marketplace Engine using an PII storage identifier associated with a PII storage request.

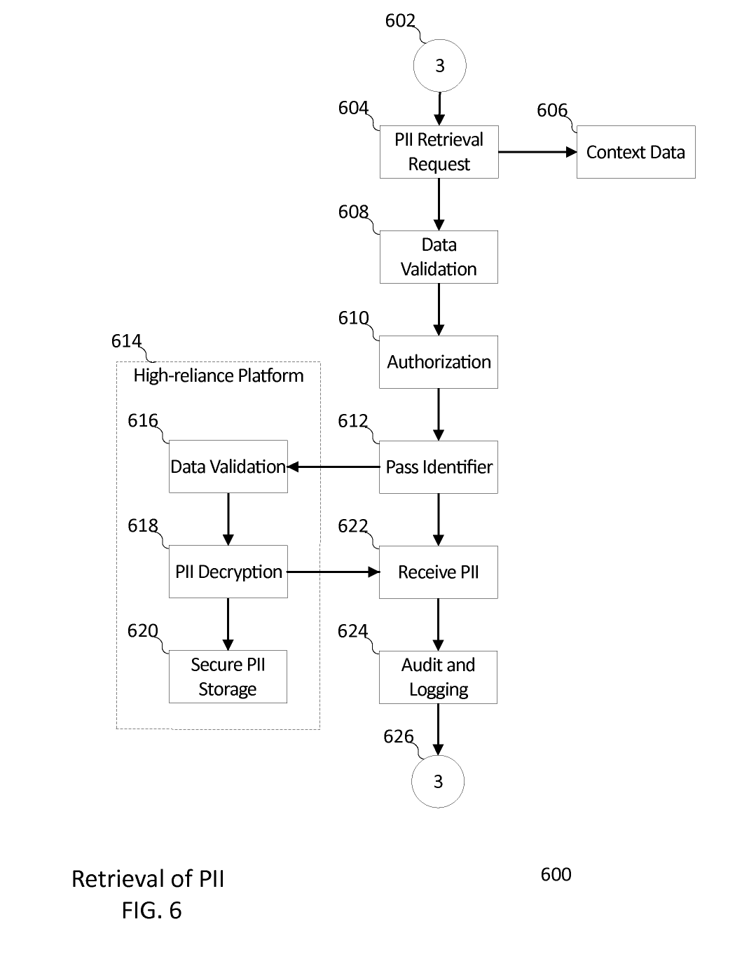

Once PII has been removed from data that is distributed, there may be a need to access the PII data associated with the processed data. Examples include, legal obligations, requests to withdraw consent after data leaves the Marketplace Engine, requests for additional use of data by the data destination, etc. FIG. 6 illustrates an example request to retrieve PII data associated with a previous PII storage request. The needed data may be identified through the association of a distribution message identifier to a PII storage identifier.

A PII retrieval request from a Marketplace Engine component symbolized at 602, is received at 604, which may retrieve additional context on the PII retrieval request from context data 606. The PII retrieval request is validated at 608 to ensure the data received is consistent with the expected data. Data validation can include, for example, analyzing data type, data range, data constraints, cross-referenced data, and data structures. Before continuing, the PII retrieval request is authorized at 610. Authorization can be based on subscription information, permissions in a database, flat file, access list, policy object, hardware token, or determined using Role Based Access Control (RBAC), Attribute Based Access Control (ABAC), Rule-Based Access Control (RuBAC) or other Mandatory Access Control (MAC) or Discretionary Access Control (DAC) mechanisms. PII storage identifier associated with the PII retrieval request is passed at 612 to the remote high-reliance platform 614 through an authenticated, secure channel, e.g. TLS. The PII retrieval request is validated at 616 and passed to PII decryption module 618. Decryption module 618 uses the PII storage identifier and cryptographic keys stored in the high-reliance cryptographic module to decrypt PII data associated with the PII storage identifier. The PII data associated with PII storage identifier is retrieved from the secure PII storage 620 and returned to component 622 in the Marketplace Engine. The result of the PII retrieval request is reported to audit and logging 624 and the requested PII data is made available at 626. In alternate use cases PII data could be used to recreate the original data prior to the removal of PII. In other use cases, a portion of the PII data, e.g., zip code, might be requested. The decryption process described herein allows secure retrieval of at least part of the stored PII data from the remote high-reliance platform by the Marketplace Engine using a PII storage identifier associated with the PII retrieval request.

A data source may require something of value before exchanging health related information. In that case, data destinations must have some measure of the data (e.g., data content, data volume, data quality, etc.) One aspect of the invention is the identification of data features. Feature parameters may vary between medical specialties, specific populations, specific investigations, etc. Medical specialties in the United States are enumerated by agencies, medical organizations, societies, etc., for example the American Board of Medical Specialties (ABMS). Medical specialties have guidelines, clinical prediction rules, diagnostic screening tools, etc., that can be adapted to serve as feature parameters. Clinical prediction rules are frequently mnemonic devices, that aid information retention, or values associated with relevant symptoms of a disease. Examples of clinical prediction rules include CHADS₂ (stroke), NACA (medical emergencies), NIHSS (stroke), etc. As an example of identifying possible features in a medical specialty, proctologists, colorectal surgeons, urologists, etc., may use the International Prostate Symptom Score (IPSS) in their practice of medicine. The IPSS includes seven questions relevant to benign prostatic hyperplasia (BPH). Data destinations developing therapies for BPH may be searching for data sets that include IPSS, substantially similar responses, relevant clinical information and outcomes. Examples of relevant clinical information, such as procedures, laboratory assessments, tumor assessments, etc. is shown in Table 5.

TABLE 5
Example Clinical Information
Procedures

| | |
|---|---|
| 1 | signed consent form |
| 2 | prior prostate therapies |
| 3 | prior prostate therapeutics |
| 4 | medical history |
| 5 | FACT-P |
| 6 | BPI SF, analgesic usage |
| 7 | BFI, fatigue |
| 8 | physical examination and weight |
| 9 | vital signs |
| 10 | ECOG |
| 11 | 12 lead ECC |
| 12 | MUGA scan or cardiac ECHO |
| 13 | dosing compliance |
| 14 | concomitant medications |
| 15 | adverse events |

Laboratory Assessments

| | |
|---|---|
| 16 | CBC |
| 17 | coagulation factors |
| 18 | PT/PTT |
| 19 | serum chemistry |
| 20 | fasting glucose |
| 21 | serum lipids |
| 22 | PSA |
| 23 | serum testosterone |
| 24 | urinalysis |
| 25 | CTC assessments |

Tumor Assessment

| | |
|---|---|
| 26 | CT/MT/other imaging procedure |
| 27 | Bone scan |
| 28 | Disease progression assessment |
| 29 | Overall survival |

Guidelines, clinical prediction rules, diagnostic screening tools, etc., provide features that are significant in diagnosing a specific disease or outcome. Categorizing relevant clinical information into features allow data sources to expose the characteristics of their data without revealing the actual content. The selection of relevant features can be provided by the data source or analytically determined. The communication of relevant features by the data source can be accomplished by sending metadata describing the features (e.g., flat file, spreadsheet, questionnaire, etc.) or the selection of features using a graphical user interface (data source GUI). The data source GUI can present categories that the data source uses to describe data, preferably organized by medical specialty. Features can also be analytically determined by the data source or the Marketplace Engine.

Analytic feature detection by the Marketplace Engine (or a member of the health services marketplace) can provide an independent assessment of the offered data. An aspect of the invention takes data from the data source and analytically identifies features in the offered data resulting in a normalized set of features suitable for the type of data being analyzed (e.g., prostate treatment data). The feature set is retained with corresponding source identification data (e.g., data source contact information, free text fields, medical specialty, population characteristics, specific investigation, geographic location, etc.) allowing the raw data sent for feature analysis to be erased. This procedure allows data destinations to search for relevant data while the data is kept under the control of the data source. Alternatively, an executable program or program running on a physical device can be provided to the data source so that features in the offered data be analyzed within the data source domain instead of transmitting the raw data set to the Marketplace Engine.

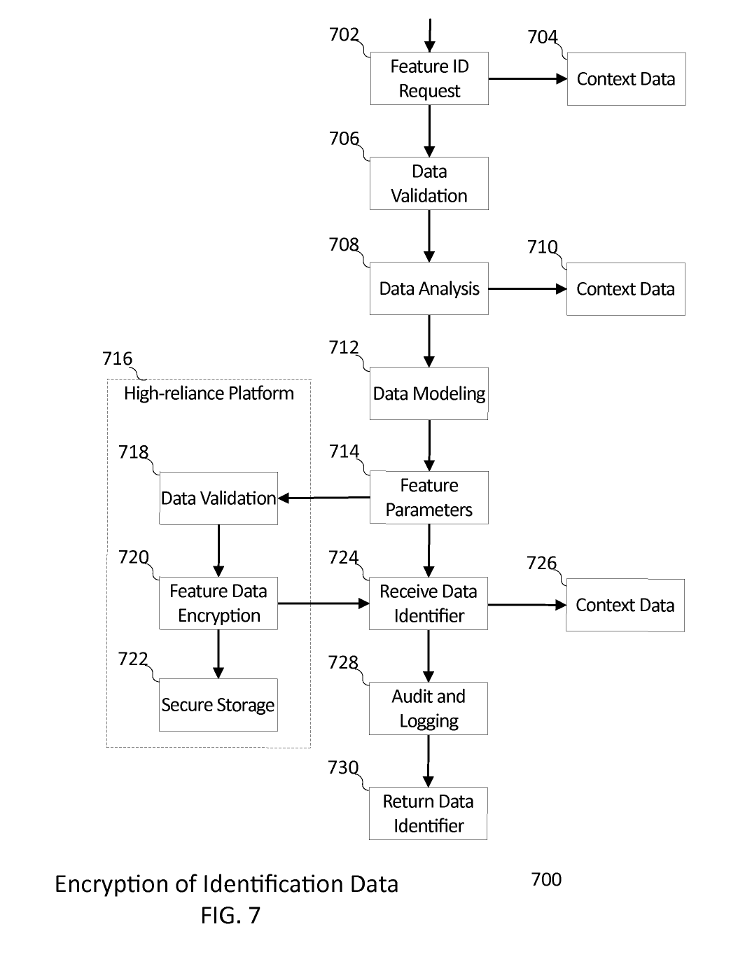

To provide additional security, the Marketplace Engine may securely store data source identification data, as shown in example FIG. 7. Feature identification request 702 receives data and associated data source identification. Data source identification data includes a unique identifier corresponding to a feature identification request and data about the data source, for example contact information (e.g., Internet address, e-mail address, physical location, telephone number, etc.), medical specialty, description of the data, and additional narrative information suitable for display to potential data destination. Data source identification data and feature identification request identifiers can be associated with data sent to subscribers using distribution message identifiers. Distribution message identifiers can identify information made available to potential consumers of data. In this way, access to data by potential consumers can be facilitated by indexing distribution message identifiers to data source identification data.

Feature identification request component 702 can access context data 704 for additional information. If feature identification is done during the request, all or part of the data and feature identification request data is validated at 706 and passed to data analysis check 708, which analytically confirms the content and category of the data using appropriate information based on specific medical specialties, specific populations, specific investigations, etc. in context data 710. The calculated similarity of the data to the description of the data is recorded as the data description fidelity term and can be stored with the analytically determined features in context data 710. The result of this analysis can be used by data modeling 712 to improve the interpretation of the data.

Data modeling 712 processes the data using appropriate data models if there is a specific domain analysis model (DAM) that can assist in the data representation. As described by Health Level Seven (HL7), a Domain Analysis Model is an abstract representation of a subject area of interest, complete enough to allow instantiation of all necessary concrete classes needed to develop child design artifacts. Transforming data using a DAM (or equivalent) provides semantic context useful in identifying feature parameters. Based on the identified category of the data and possible data modeling, feature analysis is performed at 714 to select the features of the data, e.g., parameters that are most significant. Feature significance can be measured using values correlated to a table, e.g., in a flat file, spreadsheet, database, etc., or analytically, e.g., stepwise multiple regression, variable selection using forward selection, backward elimination or variables, etc. The result of feature analysis provides categories useful for subsequent searches by data destinations. The feature identification request and source identification data, e.g., source of the data, context data, etc., is sent to high-reliance platform 716.

High-reliance platform 716 can run on an isolated environment separated from the Marketplace Engine and can be configured to be accessible by the Marketplace Engine through a secure data connection, for example using Transport Layer Security (TLS) or equivalent. Data validation module 718 receives and validates feature identification request and source identification data. Feature identification request and source identification data are encrypted by feature data encryption 720 and securely stored at 722. Feature data encryption 720 returns a feature identification storage identifier to receive data identifier 724 that can be used to identify the data. Receive data identifier 724 stores the result of feature analysis (i.e., the resultant features), feature identification request identifier, and feature identification storage identifier in context data 726. Information on the process of identifying features and securely storing feature identification request data is logged at 728 and a feature request identifier and any error codes are made available to the calling entity at 730.

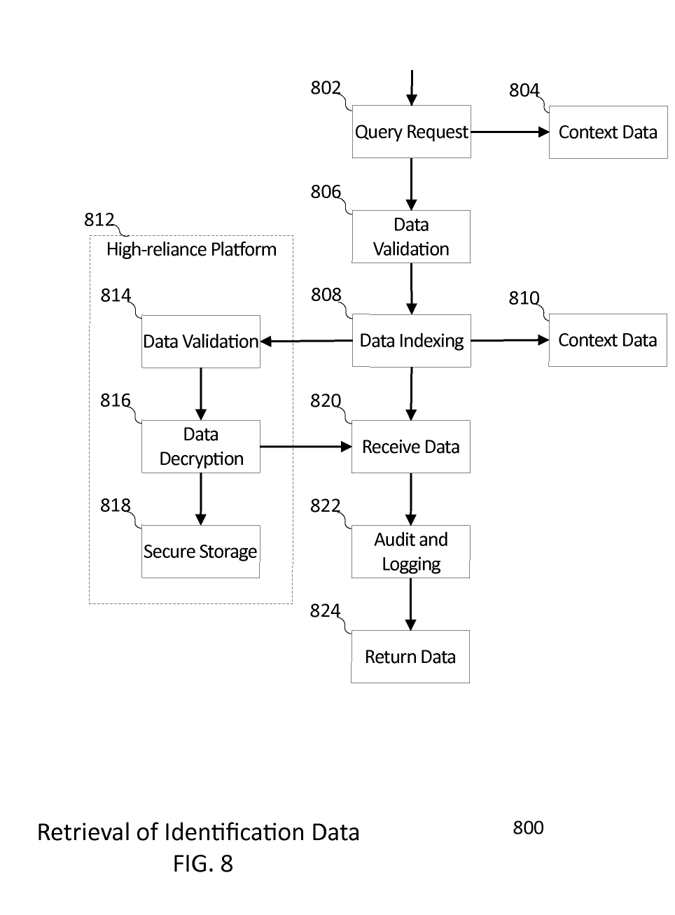

Data features and associated data can be searched by potential data destinations without revealing the data source. Request for source identification data (e.g., data source contact information, price, conditions, additional data, etc.) can be made as described in FIG. 8. Query request 802 receives source identification data request and can retrieve additional information using context data 804. The request is validated at data validation 806. Data indexing 808 identifies the feature identification storage identifier using information from context data 810. A request for source identification data is sent to high-reliance platform 812. High-reliance platform 812 can run an isolated environment separated from the Marketplace Engine and can be accessible by the Marketplace Engine through a secure data connection, for example using Transport Layer Security (TLS) or equivalent. Multiple high-reliance platforms can be used to support fail-over of a high-reliance platform. The high-reliance platform comprises specialized hardware that meets FIPS PUB 140-2 security level 2. Data from data indexing 808 is validated at 814 and passed to data scoring decryption 816. Data decryption 816 uses the feature identification storage identifier and cryptographic keys stored in the high-reliance cryptographic module to decrypt the source identification data stored in secure storage 818. Source identification data and audit and logging related data is returned by data scoring decryption 816 to receive data 820. Information on the decryption and retrieval is logged at 822 and source identification data is made available to the calling entity at 824.

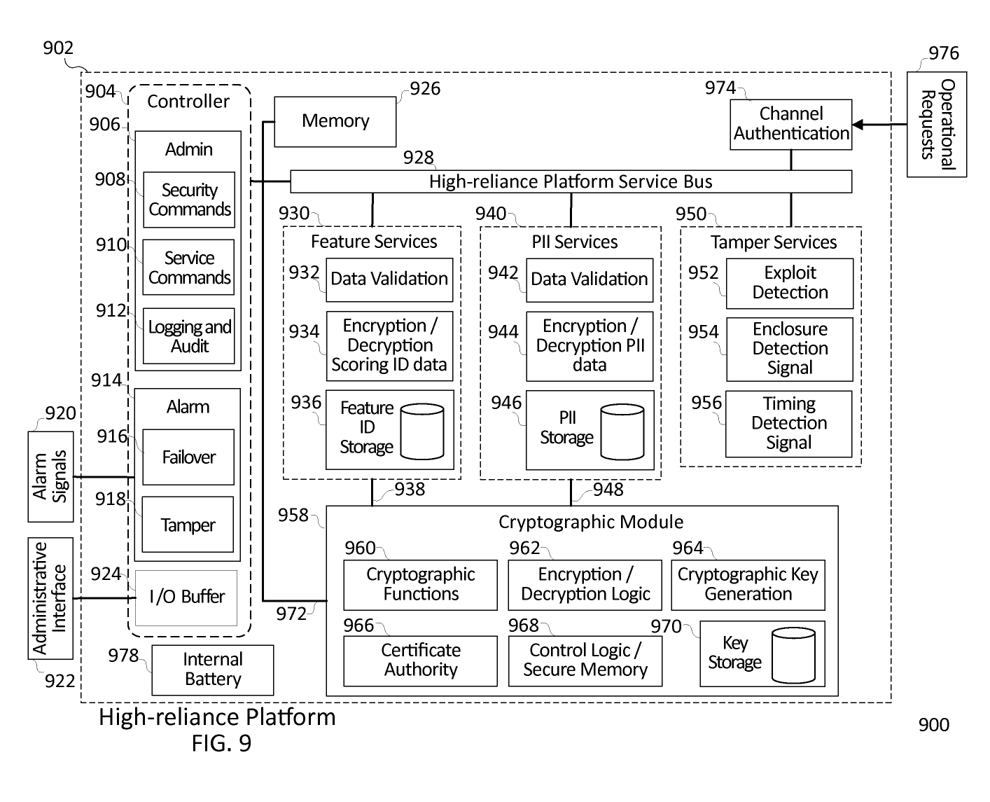

An example of the high-reliance platform is described in greater detail in FIG. 9. High-reliance platform 902 can run on an isolated environment separated from the Marketplace Engine. High-reliance platform 902 comprises a controller 904 executing operations encoded, e.g., in memory 926. Components of the high-reliance platform communicate over high-reliance platform service bus 928 to provide, e.g., feature services 930, PII services 940, tamper services 950, and cryptographic services 958. Controller 904 supports administrative 906, alarm 914, and input/output 924 capabilities.

Administrative component 906 includes security commands 908, service commands 910, and logging and audit 912. Security commands 908 allow control of commands that protect the integrity of the high-reliance platform and coordinate tamper services 950. Service commands 910, coordinate feature services 930 and PII services 940. Logging and audit 912 provides a record of high-reliance platform operations.

Alarm component 914 provides alarm signals 920, e.g., to the Marketplace Engine, in the case of failover 916 or tamper 918. Failover can be triggered, e.g., when an error is detected by controller 904 during normal operation of the high-reliance platform or the cryptographic module. A detectable error during normal operation can include, for example, internal battery malfunction, degraded clock signals, or circuit voltage fluctuations. Failover 916 signals the Marketplace Engine to use a backup high-reliance platform until the error is resolved. Tamper 918 can be triggered by signs of malicious activity from tamper detection services 950 from either the high-reliance platform or the cryptographic module. Example tamper detection sensors and circuitry include timing detection signal 956 (e.g., that detects unexpected changes in controller clock cycles), enclosure detection signal 954 (e.g., detects removal of the cover to the high reliance platform via an internal hardware switch or sensor), and exploit detection signal 952 (detecting, e.g., unexpected or unrecognizable commands received by channel authorization 974 from operational requests 976). Tamper alarm disables the high-reliance platform, e.g. zeroization of cryptographic keys held in cryptographic module 958 key storage 970. Upon detection of failover or tamper signals, security commands 908 signals the Marketplace Engine to use a backup high-reliance platform (i.e., redirects requests to another high-reliance platform). Redirection of requests to a different The high-reliance platform can be accomplished by the Marketplace Engine, for example, using a data base, flat file, hashed data object, or other data structures.

Input/output 924 capabilities supports an administrative interface 922 that is a separate interface from operational requests 976. Administrative interface 922 allows access to the operations of controller 904.

High-reliance platform 902 is configured to accept operational requests 976 through a secure data connection, e.g., Transport Layer Security (TLS) or equivalent. All requests are authenticated using channel authentication 974. Authentication can be done using exchanged Public Key Encryption (PKI) digital certificates, shared secrets, message authentication codes, etc. The set of valid operational requests can be limited to a finite set of operations. Channel authentication 974 reports unexpected requests as an indication of a malicious attack to Exploit Detection Signal 952 in Tamper Detection Services 950.

Requests for feature services, e.g., requests for feature identification data, are supplied by feature services 930 comprising data validation 932, encryption/decryption feature identification data 934, and encrypted feature identification storage 940. The requirement of encryption/decryption keys to access feature identification storage 936 allows controller 904 to prevent access to data in scoring identification storage 936 by destroying encryption/decryption keys needed for access to feature identification storage. Destroying the encryption/decryption keys to access feature identification storage takes substantially less time than zeroizaton (“wiping”) all data physically held by the storage device. Additional description of feature services is found in the text of the specification describing FIGS. 7 and 8.

Requests for personally identifiable information services are supplied by PII services 940 comprising data validation 942, encryption/decryption PII 944, and encrypted PII storage 946. The use of encryption/decryption keys allow controller 904 to immediately destroy access to all data in encrypted PII storage 948. Additional description of PII services is found in the text of the specification describing FIGS. 5 and 6.

Requests for cryptographic key services are supplied by cryptographic module 958 comprising cryptographic functions 960, encryption/decryption logic 962, cryptographic key generation 964, optional certificate authority 966, control logic/secure memory 968 and encrypted private key storage 970. Cryptographic module 958 is contained within a cryptographic boundary (solid line 958). A cryptographic boundary is a continuous perimeter that establishes the physical bounds of a cryptographic module and contains all the hardware, software, and/or firmware components of a cryptographic module. The cryptographic boundary is physically protected, allowing tamper detection and generation of a enclosure detection signal 954. Physical protection includes hardware components (cages, enclosures, frames, retaining screws, etc.) that are monitored by sensors (contact switches, electronic latches, light detectors, etc.).

Cryptographic module 958 can accept requests for encryption an decryption functions from feature services 930 via secure communications data path 938 and PII services 940 via secure communications data path 948. Encryption and decryption 962 is performed using cryptographic keys generated using cryptographic key generation 964 and cryptographic functions 960, supported by control logic/secure memory 968 and optional certificate authority 966. Communications to the cryptographic module excluding encryption and decryption requests are via path 972. Cryptographic module 958 can generate an alarm signal if errors occur within the module (i.e., failover alarm) or when access to the module circuitry is detected (i.e., tamper alarm) through the connection at 972.

High-reliance platform 902 cryptographic module 958 conforms, at a minimum, to descriptions found in Federal Information Processing Standards publication “Security Requirements For Cryptographic Modules” FIPS PUB 140-2. High-reliance platform 902 is configured to run in an isolated environment separated from the Marketplace Engine and communicates with the Marketplace Engine through a secure data connection, for example using Transport Layer Security (TLS) or equivalent. In case of power outage internal battery 974 supports lock down or disabling of the high-reliance platform, e.g., by the destruction of cryptographic keys.

We claim:

1. A networked health-related information distribution system comprising:
a marketplace engine, wherein the marketplace engine is configured to:
remove source identification data from health-related information;
associate the source identification data to a feature identification request;
identify feature data in the health-related information;
associate the feature data to the feature identification request;
a high-reliance platform configured to:
accept, via a secure communications channel, the source identification data from the marketplace engine;
encrypt and store the source identification data;
provide, via the secure communications channel, a feature identification storage identifier to the marketplace engine.

2. The method of claim 1, wherein the high-reliance platform further comprises a cryptography module configured to:
receive, over a secure communications data path, source identification data from the high-reliance platform;
encrypt source identification data using cryptographic keys that remain inside the cryptography module;
return, over a secure communications data path, encrypted source identification data to the high-reliance platform.

3. The method of claim 2, wherein cryptography module encrypts source identification using Advanced Encryption Standard symmetric-key algorithm.

4. The method of claim 1, wherein the high-reliance platform is further configured to send audit information over a secure communications channel to the high-reliance platform.

5. The method of claim 1, wherein the high-reliance platform further comprises circuitry capable of detecting tampering and wherein the circuitry disables the high-reliance platform in the event tampering is detected.

6. The method of claim 1, wherein source identification data is retrieved by the marketplace engine using the one or more of the data destination identifiers.

7. A method of distributing health-related information on a network comprising:
removing, by a marketplace engine, source identification data from health-related information;
removing, by a marketplace engine, source identification data from health-related information;
identifying, by a marketplace engine, feature data from health-related information;
sending, by the marketplace engine via a secure communications channel, the source identification data to a high-reliance platform;
encrypting, by a cryptography module, the source identification data;
providing, by the high-reliance platform via the secure communications channel, a feature identification storage identifier to the marketplace engine.

8. The method of claim 7, wherein the encrypting by the cryptography module further comprises:
receiving source identification data over a secure communications data path from the high-reliance platform; and
returning encrypted source identification data over a secure communications data path to the high-reliance platform.

9. The method of claim 8, wherein the cryptography module uses an Advanced Encryption Standard symmetric-key algorithm.

10. The method of claim 7, comprising sending, by the high-reliance platform, audit information over a secure communications channel to the marketplace engine.

11. The method of claim 7, further comprising:
detecting, by high-reliance platform circuitry, tampering of the high-reliance platform circuitry; and
redirecting, by the high-reliance platform, requests from the marketplace engine after tampering is detected.
